(19) United States
(12) Patent Application Publication
(10) Pub. No.: US 2025/0337722 A1
(43) Pub. Date: Oct. 30, 2025

(54) SINGLE SIGN-ON FOR SECURE SHELL PROTOCOL SESSIONS

(71) Applicant: Dell Products L.P., Round Rock, TX (US)

(72) Inventors: Amos Zamir, Beer Sheva (IL); Nave Ariel, Givot Bar (IL); Ofer Borosh, Lehavim (IL)

(21) Appl. No.: 18/645,216

(22) Filed: Apr. 24, 2024

(51) Int. Cl. H04L 9/40; H04L 67/141

(52) U.S. Cl. CPC H04L 63/0807; H04L 63/0815; H04L 63/0846; H04L 63/0861; H04L 67/141

(57) ABSTRACT

One example method includes receiving, at a client computing system, an identification (ID) token from an external identity provider. The ID token authenticates an identity of a user of the client computing system. A first request is provided to a server computing system for the ID token to be exchanged for a first token that is configured to allow the client computing system to establish a first Secure Shell Protocol (SSH) session with the server computing system, the first request including the ID token. The first token is received from the server computing system. The first token is used to establish the first SSH session with the server computing system.

### TECHNOLOGICAL FIELD OF THE DISCLOSURE

Embodiments disclosed herein generally relate to establishing Secure Shell Protocol (SSH) sessions. More particularly, at least some embodiments relate to systems, hardware, software, computer-readable media, and methods for implementing a Single Sign-On (SSO) authentication of SSH sessions.

### BACKGROUND

Traditional SSH sessions require client applications to authenticate individually for each session with a server when the client application requests services from the server. If the client application requests services from a number of different servers, the client application is still required to go through the authentication process for each different server. This can lead to authentication fatigue and increased administrative overhead for both the client application and for the servers, especially if a number of the servers are operated by the same entity.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A-1C disclose aspects of a system according to the embodiments disclosed herein.

FIG. 2 discloses a method according to the embodiments disclosed herein.

FIG. 3 discloses a method according to the embodiments disclosed herein.

FIG. 4 discloses an example computing entity configured to perform any of the disclosed methods, processes, and operations.

### DETAILED DESCRIPTION OF SOME EXAMPLE EMBODIMENTS

Embodiments disclosed herein generally relate to establishing Secure Shell Protocol (SSH) sessions. More particularly, at least some embodiments relate to systems, hardware, software, computer-readable media, and methods for implementing a Single Sign-On (SSO) authentication of SSH sessions.

One example embodiment includes receiving, at a client computing system, an identification (ID) token from an external identity provider. The ID token authenticates an identity of a user of the client computing system. A first request is provided to a server computing system for the ID token to be exchanged for a first token that is configured to allow the client computing system to establish a first Secure Shell Protocol (SSH) session with the server computing system, the first request including the ID token. The first token is received from the server computing system. The first token is used to establish the first SSH session with the server computing system.

Another example embodiment includes receiving, at a server computing system, a first request for an identification (ID) token to be exchanged for a first token that is configured to allow a client computing system to establish a first Secure Shell Protocol (SSH) session with the server computing system, the first request including the ID token. The server computing system verifies that the client computing system is authorized to have the ID token exchanged for the first token. The ID token is then exchanged for the first token. The first token is provided to the client computing system. The first token is used to establish the first SSH session with the client computing system.

A further example embodiment includes, at a client computing system receiving an identification (ID) token from an external identity provider, the ID token authenticating an identity of a user of the client computing system. A request is provided to a server computing system for the ID token to be exchanged for a first token that is configured to allow the client computing system to establish a Secure Shell Protocol (SSH) session with the server computing system, the request including the ID token. The token is received from the server computing system. The token is used to establish the first SSH session with the server computing system. At the server computing system, receiving the request for the token. The server computing system verifies that the client computing system is authorized to have the ID token exchanged for the token. The ID token is then exchanged for the token. The token is provided to the client computing system.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

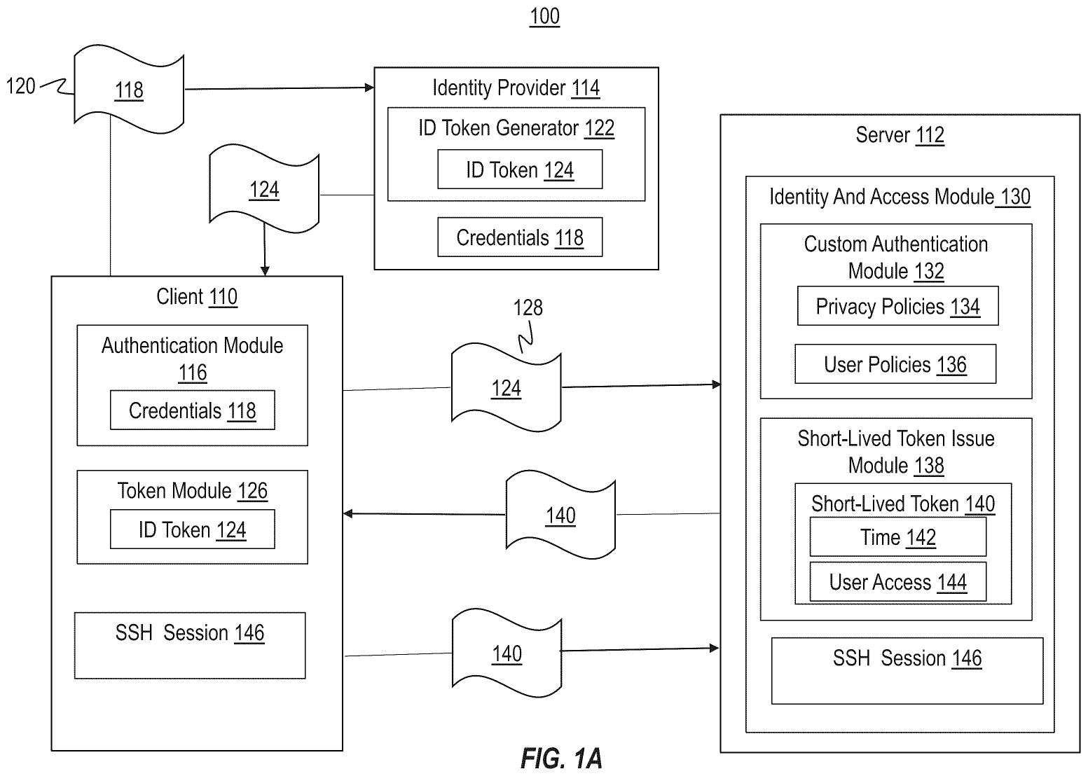

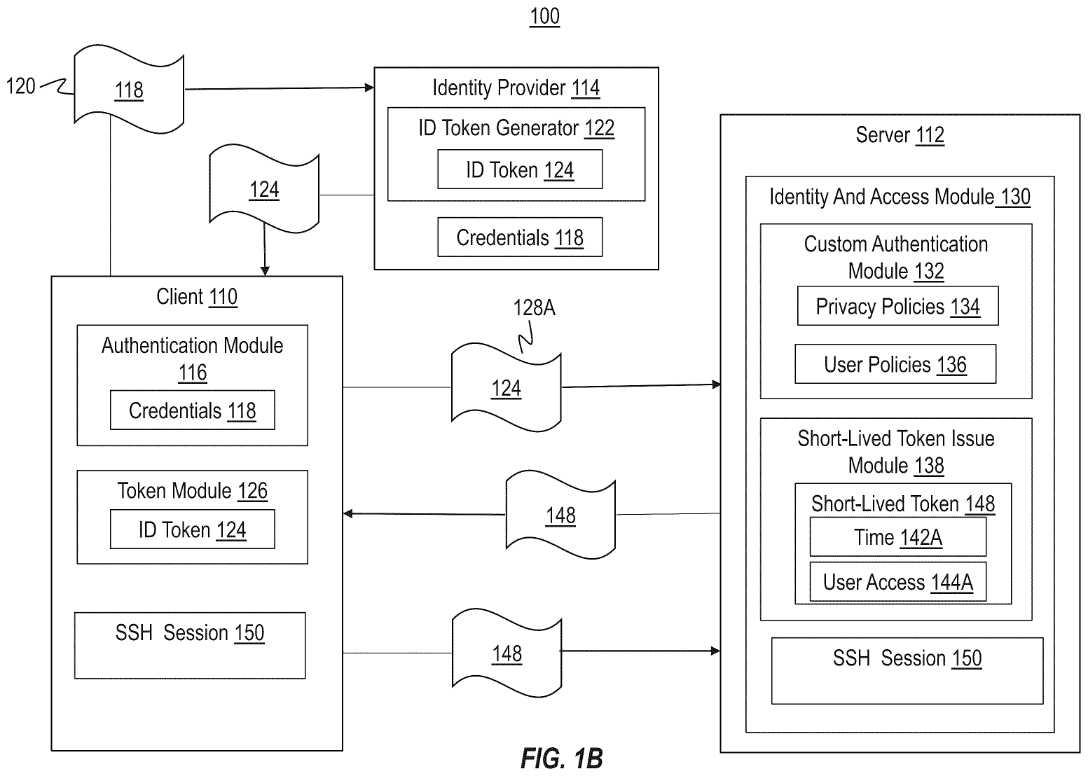

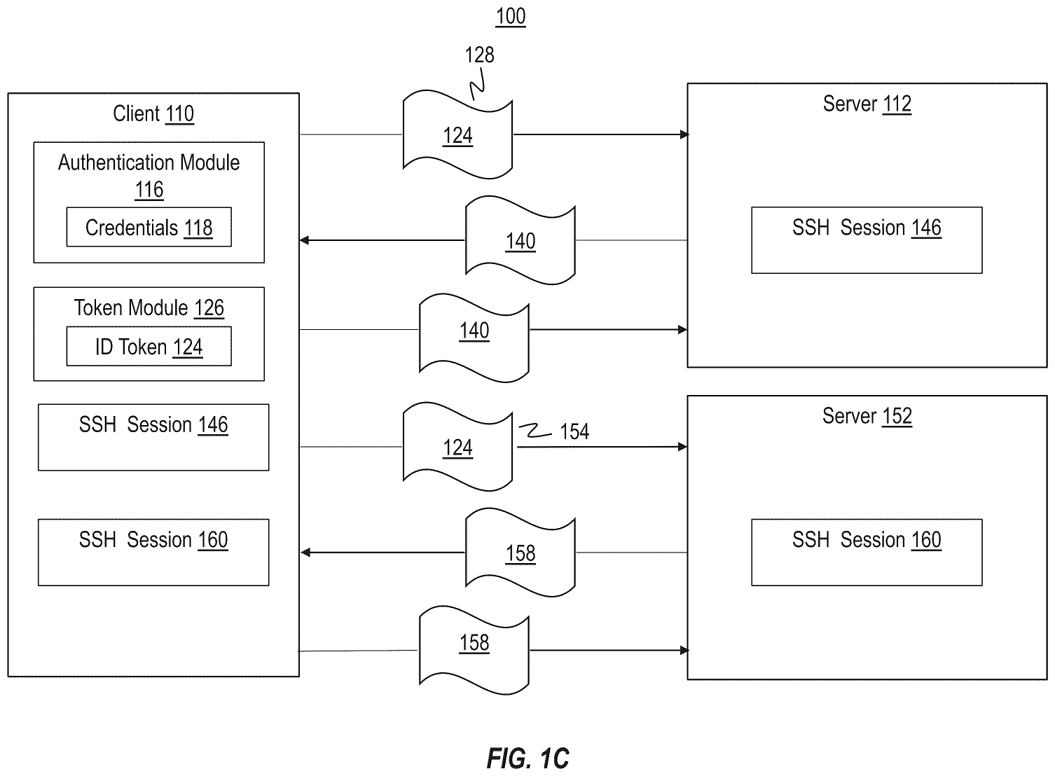

FIG. 1A illustrates a system 100 where the embodiments disclosed herein may be practiced. As shown in FIG. 1A, the system 100 includes a client 110, a server 112, and an identity provider 114. The client 110 may be any reasonable client computing system and may run one more user applications that require one or more services that are run on the server 112. Thus, the server 112, which may be any reasonable computing system, is able to provide access to the client 110 so that the client 110 can use the services that run on the server 112.

The identity provider 114 may be any reasonable identity provider. In the embodiments disclosed herein, the identity provider 114 may be independent of the operators of the client 110 and the server 112. In operation, the identity provider 114 is an entity that is trusted by both the client 110 and the server 112 and is therefore trusted to provide a verification of the identity of the client 110 for the server 112.

The client 110 includes an authentication module 116. In operation, the authentication module 116 allows a user of the client 110 to enter user credentials 118 that are used to identify the user. The user credentials 118 may include a username and password, biometric credentials such as a fingerprint or facial recognition, a numeric code, or a QR code. Thus, the user credentials 118 may be any reasonable and known credentials that can be used to uniquely identify the user of the client 110.

In operation, when the client 110 needs to access the services of the server 112, the client 110 sends an authentication request 120 including the user credentials 118 to the identity provider 114. As mentioned previously, the identity provider 114 is an entity that is trusted by the client 110. Accordingly, the identity provider 114 stores or otherwise has access to the user credentials 118. Upon receipt of the authentication request 120, the identity provider 114 verifies that the user credentials 118 included in the authentication request 120 match the user credentials 118 stored at or otherwise accessed by the identity provider 114. For example, if the user credentials 118 provided in the authentication request 120 are a username and password, the identity provides will verify that the username and password match the username and password that is stored at or otherwise accessible to the identity provider 114.

The identity provider 114 includes an identification (ID) token generator 122. Upon verification that the user credentials 118 included in the authentication request 120 match the user credentials 118 stored at or otherwise accessible by the identity provider 114, the ID token generator 122 generates an ID token 124.

The ID token 124 may be implemented as a Security Assertion Markup Language (SAML) token. The ID token 124 is signed by the identity provider 114 and verifies the identity of the user of the client 110. The ID token 124 is then returned to the client 110.

The client 110 includes a token module 126. In operation, the token module 126 sends a request 128 that includes the ID token 124 to the server 112. The request 128 is a request to exchange the ID token 124 for a short-lived token 140 that will allow the client 110 to establish a SSH session with the server 112 as will be explained in more detail to follow.

The server 112 includes an identity and access module 130 that in operation verifies the identity of clients requesting access to the server and that controls the access that is given. The identity and access module 130 includes a custom authentication module 132 that receives the request 128 from the client 110. The custom authentication module 132 initially authenticates the the ID token 124 to verify the identity of the user of the client 110. If the ID token 124 is not verified, the custom authentication module 132 will deny access to the client 110 as the server 112 will not know the identity of the user of the client 110.

However, when the ID token 124 is verified, the custom authentication module 132 then performs a custom authentication operation to further verify if the client 110 is authorized to exchange the ID token 124 for a short-lived token. As shown in FIG. 1A, the custom authentication module 132 includes privacy policies 134. The privacy polices 134 are policies set by the operator of the server 112 and specifies rules about when an ID token can be exchanged for a short-lived token. For example, the privacy policies may specify that requests received from clients located in an untrusted region of the world are not eligible to exchange the ID token 124 for a short-lived token due to security concerns. The privacy policies 134 may also specify the scope of the access that may be given to the client 110

The custom authentication module 132 includes user policies 136. The user policies 136 may specify specific rules that apply to the user of the client 110. For example, one user policy 136 may specify if the user of the client 110 is allowed to exchange the ID token 124 for a short-lived token. Other user policies 136 may specify the scope of access that is to be given to the user of the client 110.

The identity and access module 130 includes a short-lived token issue module 138. In operation, the short-lived token issue module 138 exchanges or converts the ID token 124 into a short-lived token 140. The short-lived token 140 is cryptographically signed by the identity and access module 130, thus verifying that the short-lived token has been generated at the server 112. The short-lived token 140 may be implemented and encrypted using the Pretty Good Privacy (PGP) protocol.

The short-lived token 140 is considered “short-lived” because it only exists for a relatively limited amount of time before it will expire. For example, the short-lived token 140 includes a time 142 that predefines how long the short-lived token 140 will exist. In one embodiment, the time 142 may be set to one hour as an hour can be considered a relatively short amount of time. In other embodiments, the time 142 may be set to less than one hour or even to more than one hour. Thus, the time 142 may be set to any reasonable amount of time. However, by limiting the amount of time that the short-lived token 140 is active provides enhanced security because the short-lived token 140 will expire in a short amount of time if the token has been comprised or used to access the server 112 in an unauthorized manner.

In some embodiments, the short-lived token 140 also incudes user access information 144. The user access information 144 can be used to specify the scope of access that is to be given to the user of the client 110 based on the privacy policies 134 and/or the user policies 136. Once generated, the short-lived token 140 is returned to the client 110.

After the client 110 receives the short-lived token 140, the client 110 can use the short-lived token 140 to establish a SSH session 146 with the server 112. The SSH session allows the client to access the services of the server 112 in a secure way. In particular, since the short-lived token 140 is cryptographically signed by the identity and access module 130, the server 112 can trust the SSH session 146 is with a trusted party.

As mentioned previously, the time 142 defines how long the short-lived token 140 will be active. For example, suppose that the time 142 specified one hour as the time for the short-lived token 140 to be active. At the end of the one hour, the short-lived token would expire and thus could not be used again to establish the SSH session 146.

FIG. 1B illustrates an embodiment of the system 100 at a time after the short-lived token 140 has expired. For example, suppose that the time 142 specified an hour and that an hour has passed. Accordingly, in the embodiment of FIG. 1B the short-lived token 140 can no longer be used to establish a SSH session between the client 110 and the server 112.

In the embodiment of FIG. 1B, however, the token module 126 of the client 110 still stores or otherwise has access to the ID token 124 that was generated by the identity provider 114 and returned to the client 110 as described previously in relation to FIG. 1A. Accordingly, the token module 126 sends a new request 128A that includes the ID token 124 to the server 112. The request 128A is a request to exchange the ID token 124 for a new short-lived token that is different from the short-lived token 140 that will allow the client 110 to establish a new SSH session with the server 112.

As shown in FIG. 1B, the custom authentication module 132 verifies the ID token 124 in the manner previously described. In addition, the custom authentication module 132 performs the custom authentication operation to further verify if the client 110 is still authorized to exchange the ID token 124 for a short-lived token in the manner previously described.

The short-lived token issue module 138 then exchanges or converts the ID token 124 into a new short-lived token 148. The short-lived token 148 is cryptographically signed by the identity and access module 130, thus verifying that the short-lived token has been generated at the server 112. The short-lived token 148 may be implemented and encrypted using the Pretty Good Privacy (PGP) protocol.

The short-lived token 148 may include a time 142A that defines the short amount or limited amount of time that the short-lived token 148 will be active. The time 142A may be set according to the previous discussion in relation to time 142.

In some embodiments, the short-lived token 148 also includes user access information 144A. It will be appreciated that the user access information 144A may be different from the user access information 144 as the access that the server 112 is willing to give to the client 110 may have changed since the short-lived token 140 was generated. The user access information 144A can be used to specify the scope of access that is to be given to the user of the client 110 based on the privacy policies 134 and/or the user policies 136. Once generated, the short-lived token 148 is returned to the client 110.

After the client 110 receives the short-lived token 148, the client 110 can use the short-lived token 148 to establish a SSH session 150 with the server 112. The SSH session 150 allows the client 110 to access the services of the server 112 in the secure way. In particular, since the short-lived token 148 is cryptographically signed by the identity and access module 130, the server 112 can trust the SSH session 150 is with a trusted party.

The embodiment of FIG. 1B illustrates one of the advantages of the embodiments disclosed herein. In particular, the client 110 did not have to authenticate with the identity provider 114 before it could establish the SSH session 150 with the server 112. Rather, once the ID token 124 is received from the identity provider 114 during the initial cycle, there is no need to perform repetitive ID authentications with the identity provider 114. During subsequent cycles such as that shown in FIG. 1B, the ID token 124 can be used to obtain a new short-lived token 148 as needed so that additional SSH sessions can be established between the client 110 and the server 112, thus removing the burden of entering the user credentials 118 multiple times and thereby reducing user friction and increasing user and system efficiency. Accordingly, the process of FIG. 1B shows that the embodiments disclosed herein provide for a Single Sign-On (SSO) authentication of SSH sessions since the client 110 is only required to authenticate with the identity provider 114 once during the process/

FIG. 1C illustrates a further embodiment of the system 100. In the embodiment of FIG. 1C, the client 110 and the server 112 have performed the process described previously in relation to FIG. 1A and have established the SSH session 146. Although for ease of illustration, the process of obtaining the ID token 124 from the identity provider 114 is not shown in FIG. 1C, the ID token 124 is obtained as by the client 110 in the manner previously described.

In the embodiment of FIG. 1C, the system 100 includes a second server 152 having services the client 110 needs to access. Although not illustrated for ease of explanation, the server 152 includes an identity and access module having a custom authentication module and short-lived token issue module that correspond to the identity and access module 130, the custom authentication module 132, and the short-lived token issue module 138. Thus, the server 152 is able to perform the operations described previously for server 112.

As described previously, the token module 126 of the client 110 still stores or otherwise has access to the ID token 124 that was generated by the identity provider 114 and returned to the client 110 as described previously. Thus, the token module 126 sends a new request 154 that includes the ID token 124 to the server 152. The request 154 is a request to exchange the ID token 124 for a new short-lived token that will allow the client 110 to establish a SSH session with the server 152.

Although not illustrated in FIG. 1C, the custom authentication module of the server 152 verifies the ID token 124 in the manner previously described. In addition, the custom authentication module performs the custom authentication operation to further verify if the client 110 is authorized to exchange the ID token 124 for a short-lived token for establishing a SSH session with the server 152 in the manner previously described.

The short-lived token issue module of the server 152 then exchanges or converts the ID token 124 into a short-lived token 158. The short-lived token 158 is cryptographically signed by the identity and access module of the server 152, thus verifying that the short-lived token 158 has been generated at the server 152. The short-lived token 158 may be implemented and encrypted using the Pretty Good Privacy (PGP) protocol.

The short-lived token 158 may include a time that defines the short amount or limited amount of time that the short-lived token 158 will be active. The time may be set according to the previous discussion in relation to time 142. In addition,

In some embodiments, the short-lived token 158 also includes user access information. The user access information can be used to specify the scope of access that is to be given to the user of the client 110 to the services of the server 152 based on the privacy policies and/or the user policies of the server 152. Once generated, the short-lived token 158 is returned to the client 110 as shown n FIG. 1C.

After the client 110 receives the short-lived token 158, the client 110 can use the short-lived token 158 to establish a SSH session 160 with the server 152. The SSH session 160 allows the client 110 to access the services of the server 152 in the secure way. In particular, since the short-lived token 158 is cryptographically signed by the identity and access module of the server 152, the server 152 can trust the SSH session 160 is with a trusted party.

The embodiment of FIG. 1C illustrates one of the advantages of the embodiments disclosed herein. In particular, the client 110 did not have to authenticate with the identity provider 114 before it could establish the SSH session 160 with the server 152. Rather, once the ID token 124 is received from the identity provider 114 during the initial cycle, there is no need to perform repetitive ID authentications with the identity provider 114 when establishing SSH sessions with multiple servers. During subsequent cycles such as that shown in FIG. 1C, the ID token 124 can be used to obtain the short-lived token 158 as needed so that SSH sessions can be established between the client 110 and the server 152 after the SSH session 146 has established between the client 110 and the server 112, thus removing the burden of entering the user credentials 118 multiple times and thereby again reducing user friction and increasing user and system efficiency. It will appreciated that once the ID token 124 has been obtained by the client 110, the client 110 can use the ID token 124 in the manner described in FIG. 1C to obtain any number of short-lived tokens for use in establishing SSH sessions with any number of servers as circumstances require without the need to constantly receive new ID tokens.

Accordingly, the embodiments disclosed herein provide at least the following non-limiting results:
1. Enhanced User Experience: The embodiments herein enhance user experience by eliminating the need for repetitive authentication in SSH sessions. Clients authenticate once with the external identity provider (IDP) and receive an ID token, which is then used to obtain short-lived PGP tokens from the server. This streamlined process eliminates the burden of entering credentials multiple times, reducing user friction and increasing efficiency.
2. Strengthened Security Measures: The usage of short-lived PGP tokens instead of traditional long-lived SSH key pairs enhances security. By employing time-limited tokens, the risk of compromised keys or unauthorized access is mitigated. Furthermore, the server's custom authorization module ensures that only authorized clients can initiate the token exchange process disclosed herein, further bolstering security measures and preventing unauthorized access to SSH sessions.
3. Simplified SSH Session Management: Traditionally, managing multiple SSH key pairs for different servers can be challenging and prone to errors. With the embodiments disclosed herein, clients can reuse the original token to exchange it for additional short-lived PGP tokens. This allows for simplified SSH session management, as clients can establish SSH sessions with multiple servers without the need to authenticate separately for each session. This streamlined approach reduces administrative overhead and improves operational efficiency.
4. Compliance and Auditing Capabilities: The utilization of an identity and access module at the server introduces compliance and auditing capabilities to SSH sessions. The token exchange process disclosed herein, facilitated by the identity and access module, allows for granular control over client access. This level of control enables organizations to enforce compliance policies and track SSH session activities, ensuring regulatory compliance and simplifying auditing processes.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

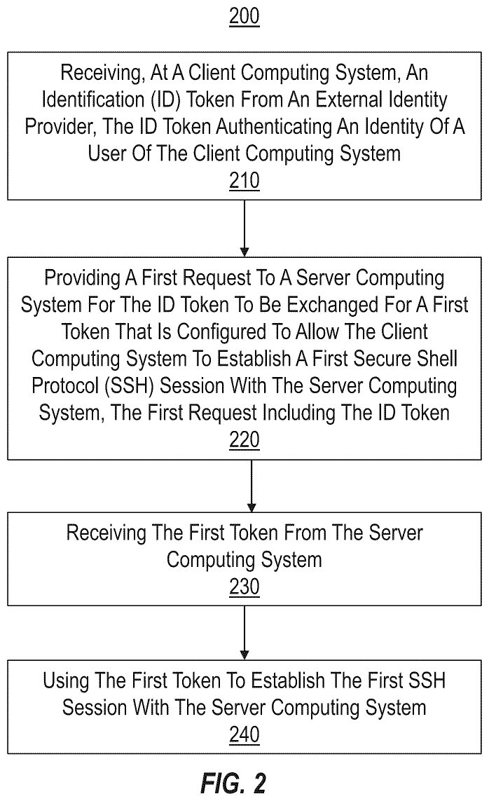

Directing attention now to FIG. 2, an example method 200 is disclosed. The method 200 will be described in relation to one or more of the figures previously described, although the method 200 is not limited to any particular embodiment.

The method 200 includes receiving, at a client computing system, an identification (ID) token from an external identity provider, the ID token authenticating an identity of a user of the client computing system (210). For example, as previously described the client 110 receives the ID token 124 from the identity provider 114. The ID token 124 verifies the identity of the user of the client 110.

The method 200 includes providing a first request to a server computing system for the ID token to be exchanged for a first token that is configured to allow the client computing system to establish a first Secure Shell Protocol (SSH) session with the server computing system, the first request including the ID token (220). For example, as previously described the client 110 provides the request 128 including the ID token 124 to the server 112.

The method 200 includes receiving the first token from the server computing system (230). For example, as previously described the client 110 receives the short-lived token 140, which may be a PGP token, from the server 112 after the server 112 has exchanged the ID token 124 for the short-lived token 140.

The method 200 includes using the first token to establish the first SSH session with the server computing system (240). For example, as previously described the client 110 uses the short-lived token 140 to establish a SSH session with the server 112.

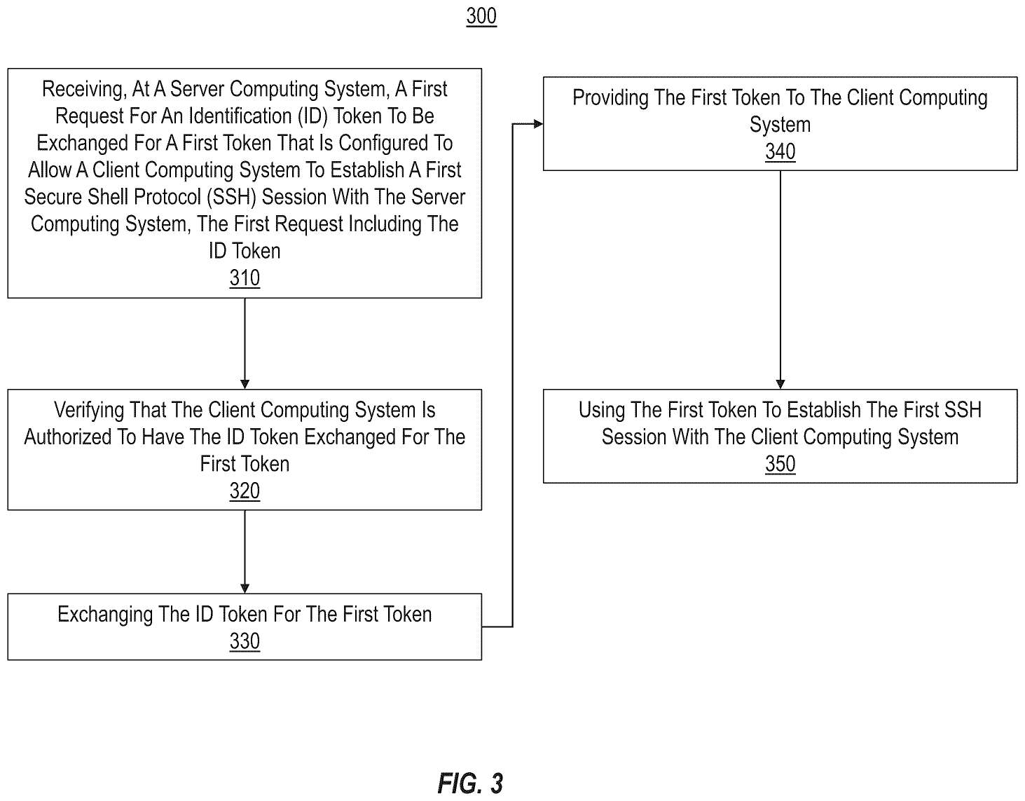

Directing attention now to FIG. 3, an example method 300 is disclosed. The method 300 will be described in relation to one or more of the figures previously described, although the method 300 is not limited to any particular embodiment.

The method 300 includes receiving, at a server computing system, a first request for an identification (ID) token to be exchanged for a first token that is configured to allow a client computing system to establish a first Secure Shell Protocol (SSH) session with the server computing system, the first request including the ID token (310). For example, as previously described the server 112 receives the request including the ID token 124 from the client 110.

The method 300 includes verifying that the client computing system is authorized to have the ID token exchanged for the first token (320). For example, as previously described the custom authentication module 132 of the server 112 verifies that the client 110 is authenticated to have the ID token 124 exchanged for the short-lived token 140.

The method 300 includes exchanging the ID token for the first token (330). For example, as previously described the short-lived token issue module 138 of the server 112 exchanges the ID token 124 for the short-lived token 140.

The method 300 includes providing the first token to the client computing system (340). For example, as previously described the server 112 provides the short-lived token 140 to the client 110.

The method 300 includes using the first token to establish the first SSH session with the server computing system (350). For example, as previously described the short-lived token 140 is used to establish a SSH session between the client 110 and the server 112.

### Further Example Embodiments

Following are some further example embodiments of the invention. These are presented only by way of example and are not intended to limit the scope of the invention in any way.

Embodiment 1. A method, comprising: receiving, at a client computing system, an identification (ID) token from an external identity provider, the ID token authenticating an identity of a user of the client computing system; providing a first request to a server computing system for the ID token to be exchanged for a first token that is configured to allow the client computing system to establish a first Secure Shell Protocol (SSH) session with the server computing system, the first request including the ID token; receiving the first token from the server computing system; and using the first token to establish the first SSH session with the server computing system.

Embodiment 2. The method as recited in embodiment 1, further comprising: providing a second request to the server computing system for the ID token to be exchanged for a second token that is configured to allow the client computing system to establish a second SSH session with the server computing system, the second request including the ID token, wherein a second ID token need not be received from the external identity provider before making the second request; receiving the second token from the server computing system; and using the second token to establish the second SSH session with the server computing system.

Embodiment 3. The method as recited in embodiments 1-2, further comprising: providing a third request to a second server computing system that is different from the first server computing system for the ID token to be exchanged for a third token that is configured to allow the second client computing system to establish a third SSH session with the second server computing system, the third request including the ID token, wherein a second ID token need not be received from the external identity provider before making the third request; receiving the third token from the second server computing system; and using the third token to establish the third SSH session with the third server computing system.

Embodiment 4. The method as recited in any of embodiments 1-3, further comprising: providing a fourth request to the second server computing system for the ID token to be exchanged for a fourth token that is configured to allow the second client computing system to establish a fourth SSH session with the second server computing system, the fourth request including the ID token, wherein a second ID token need not be received from the external identity provider before making the fourth request; receiving the fourth token from the second server computing system; and using the fourth token to establish the fourth SSH session with the third server computing system.

Embodiment 5. The method as recited in any of embodiments 1-4, wherein the first token includes user access information that specifies a level of access that is to be given to the user of the client computing system.

Embodiment 6. The method as recited in any of embodiments 1-5, wherein the first token is a short-lived token that expires according to a predetermined amount of time.

Embodiment 7. The method as recited embodiment 6, wherein the predetermined amount of time is one hour or less.

Embodiment 8. The method as recited in any of embodiments 1-7, further comprising: providing user credentials to the external identity provider; and in response, receiving the ID token.

Embodiment 9. The method as recited in embodiment 8, wherein the user credentials are one of a username and password, a biometric credential, numeric code, or QR code.

Embodiment 10. A method, comprising: receiving, at a server computing system, a first request for an identification (ID) token to be exchanged for a first token that is configured to allow a client computing system to establish a first Secure Shell Protocol (SSH) session with the server computing system, the first request including the ID token; verifying that the client computing system is authorized to have the ID token exchanged for the first token; exchanging the ID token for the first token; providing the first token to the client computing system; and using the first token to establish the first SSH session with the client computing system.

Embodiment 11. The method as recited in embodiment 10, further comprising: receiving, at the server computing system, a second request for the ID token to be exchanged for a second token that is configured to allow the client computing system to establish a second SSH session with the server computing system, the second request including the ID token; verifying that the client computing system is authorized to have the ID token exchanged for the second token; exchanging the ID token for the second token; providing the second token to the client computing system; and using the second token to establish the second SSH session with the client computing system.

Embodiment 12. The method as recited in embodiments 10-11, wherein verifying that the client computing system is authorized to have the ID token exchanged for the first token comprises: applying one or more privacy policies and user policies that specify if the client computing system is authorized to have the ID token exchanged for the first token.

Embodiment 13. The method as recited in any of embodiments 10-12, wherein the first token includes user access information that specifies a level of access that is to be given to the client computing system.

Embodiment 14. The method as recited in any of embodiments 10-13, wherein the first token is a short-lived token that expires according to a predetermined amount of time.

Embodiment 15. The method as recited embodiment 14, wherein the predetermined amount of time is one hour or less.

Embodiment 16. The method as recited in any of embodiments 10-15, wherein the ID token is provided by an identify provider that is an entity trusted by the server computing system.

Embodiment 17. A system, comprising hardware and/or software, operable to perform any of the operations, methods, or processes, or any portion of any of these, disclosed herein.

Embodiment 18. A non-transitory storage medium having stored therein instructions that are executable by one or more hardware processors to perform operations comprising the operations of any one or more of embodiments 1-16.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

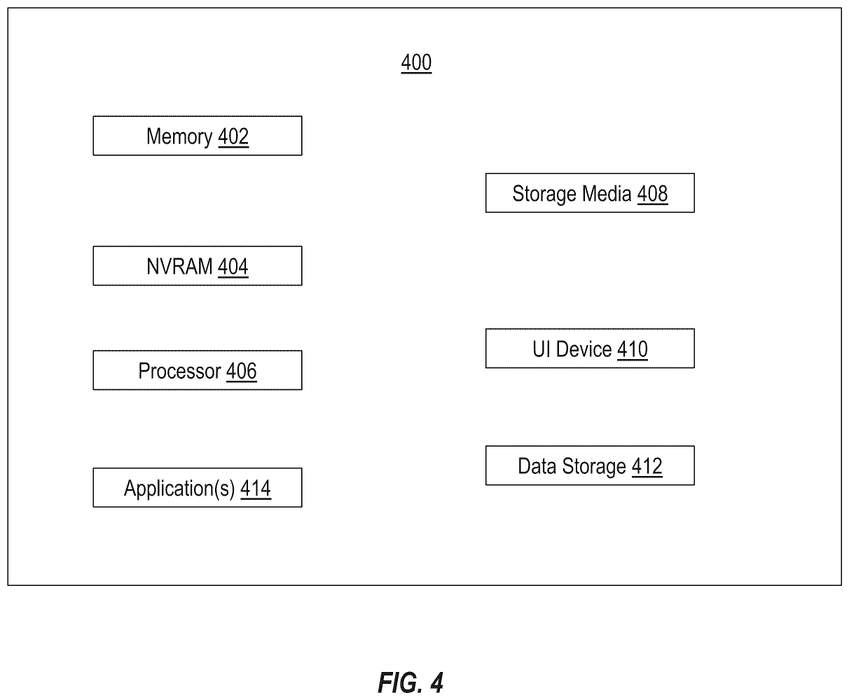

With reference briefly now to FIG. 4, any one or more of the entities disclosed, or implied, by FIGS. 1A-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, at a client computing system, an identification (ID) token from an external identity provider, the ID token authenticating an identity of a user of the client computing system;
providing a first request to a server computing system for the ID token to be exchanged for a first token that is configured to allow the client computing system to establish a first Secure Shell Protocol (SSH) session with the server computing system, the first request including the ID token;
receiving the first token from the server computing system; and
using the first token to establish the first SSH session with the server computing system.

2. The method of claim 1, further comprising:
providing a second request to the server computing system for the ID token to be exchanged for a second token that is configured to allow the client computing system to establish a second SSH session with the server computing system, the second request including the ID token, wherein a second ID token need not be received from the external identity provider before making the second request;
receiving the second token from the server computing system; and
using the second token to establish the second SSH session with the server computing system.

3. The method of claim 1, further comprising:
providing a third request to a second server computing system that is different from the first server computing system for the ID token to be exchanged for a third token that is configured to allow the client computing system to establish a third SSH session with the second server computing system, the third request including the ID token, wherein a second ID token need not be received from the external identity provider before making the third request;
receiving the third token from the second server computing system; and
using the third token to establish the third SSH session with the third server computing system.

4. The method of claim 3, further comprising:
providing a fourth request to the second server computing system for the ID token to be exchanged for a fourth token that is configured to allow the second client computing system to establish a fourth SSH session with the second server computing system, the fourth request including the ID token, wherein a second ID token need not be received from the external identity provider before making the fourth request;
receiving the fourth token from the second server computing system; and
using the fourth token to establish the fourth SSH session with the third server computing system.

5. The method of claim 1, wherein the first token includes user access information that specifies a level of access that is to be given to the user of the client computing system.

6. The method of claim 1, wherein the first token is a short-lived token that expires according to a predetermined amount of time.

7. The method of claim 6, wherein the predetermined amount of time is one hour or less.

8. The method of claim 1, further comprising:
providing user credentials to the external identity provider; and
in response, receiving the ID token.

9. The method of claim 8, wherein the user credentials are one of a username and password, a biometric credential, numeric code, or QR code.

10. A method, comprising:
receiving, at a server computing system, a first request for an identification (ID) token to be exchanged for a first token that is configured to allow a client computing system to establish a first Secure Shell Protocol (SSH) session with the server computing system, the first request including the ID token;
verifying that the client computing system is authorized to have the ID token exchanged for the first token;
exchanging the ID token for the first token;
providing the first token to the client computing system; and
using the first token to establish the first SSH session with the client computing system.

11. The method of claim 10, further comprising:
receiving, at the server computing system, a second request for the ID token to be exchanged for a second token that is configured to allow the client computing system to establish a second SSH session with the server computing system, the second request including the ID token;
verifying that the client computing system is authorized to have the ID token exchanged for the second token;
exchanging the ID token for the second token;
providing the second token to the client computing system; and
using the second token to establish the second SSH session with the client computing system.

12. The method of claim 10, wherein verifying that the client computing system is authorized to have the ID token exchanged for the first token comprises:
applying one or more privacy policies and user policies that specify if the client computing system is authorized to have the ID token exchanged for the first token.

13. The method of claim 10, wherein the first token includes user access information that specifies a level of access that is to be given to the client computing system.

14. The method of claim 10, wherein the first token is a short-lived token that expires according to a predetermined amount of time.

15. The method of claim 14, wherein the predetermined amount of time is one hour or less.

16. The method of claim 10, wherein the ID token is provided by an identify provider that is an entity trusted by the server computing system.

17. A method comprising:
at a client computing system:
receiving an identification (ID) token from an external identity provider, the ID token authenticating an identity of a user of the client computing system;
providing a request to a server computing system for the ID token to be exchanged for a first token that is configured to allow the client computing system to establish a Secure Shell Protocol (SSH) session with the server computing system, the request including the ID token;
receiving the token from the server computing system; and
using the token to establish the first SSH session with the server computing system; and
at the server computing system:
receiving the request for the token;
verifying that the client computing system is authorized to have the ID token exchanged for the token;
exchanging the ID token for the token; and
providing the token to the client computing system.

18. The method of claim 17, wherein the token includes user access information that specifies a level of access that is to be given to the user of the client computing system.

19. The method of claim 17, wherein the token is a short-lived token that expires according to a predetermined amount of time.

20. The method of claim 19, wherein the predetermined amount of time is one hour or less.
